(19) United States
(12) Patent Application Publication
(10) Pub. No.: US 2002/0172176 A1
(43) Pub. Date: Nov. 21, 2002

(54) Distributed bluetooth communications network

(76) Inventor: Nick Moss, Middlesex (GB)

Correspondence Address: BEYER WEAVER & THOMAS LLP, P.O. BOX 778, BERKELEY, CA, 94704-0778, US

(21) Appl. No.: 10/049,490

(22) PCT Filed: Jun. 13, 2001
(86) PCT No.: PCT/GB01/02586

(30) Foreign Application Priority Data
Jun. 13, 2000 (GB) 0014431.1
Dec. 4, 2000 (GB) 0029534.5

(51) Int. Cl. H04Q 7/24

(52) U.S. Cl. 370/338; 370/349

(57) ABSTRACT

The present invention provides a system in which a number of independent nodes in a communications network are connected in series to a server controlling the nodes. Each node in the network is capable of independently transmitting and receiving data over a wireless connection. In a preferred embodiment this is achieved by splitting the processing stack between the nodes and the server. Furthermore, in the present invention the server includes a power supply which is coupled to the nodes via the communications link. The power is transferred from the power supply to the nodes via the series communications link. This further simplifies the wiring required for the communications system.

### FIELD OF THE INVENTION

The present invention relates to a communications network adapted to communicate with communications devices via wireless connections, and in particular, with Bluetooth connections.

### BACKGROUND OF THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Application Protocol) phones. Internet access is also possible via a cellular phone, a GSM modem and a PC/PDA.

In addition to this, the local communication standards are also provided for short-range radio communication. These systems have been used within the production of wireless networks.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference. Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 Kbits per second and 57.6 Kbits per second and symmetric data rates of up to 432.5 Kbits per second. Data transfers may be over synchronous connections, Bluetooth supports up to three pairs of symmetric synchronous voice channels of 64 Kbits per second each.

Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and, addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet, in which some devices participate in more that one piconet on a time division multiplex basis. These and any other piconets are not time or frequency synchronized, each piconet maintains is own independent master clock and hopping sequence.

The disadvantage with the Bluetooth system is that the Bluetooth radios only have a very short range, typically a few meters. Accordingly, if it is required to provide Bluetooth connectivity over a wide area, such as throughout an airport, company offices or the like, it is necessary to provide a number of separate Bluetooth enabled computers throughout the building. This effectively leads to the formation of a number of independent Bluetooth networks throughout the building. The interconnection of several independent networks is not trivial and requires that the networks are correctly configured for interaction. This means that Bluetooth connectivity cannot normally be provided from one location in the building to another.

### SUMMARY OF THE INVENTION

In accordance with a first aspect of the present invention, we provide a communications network adapted to communicate with communications devices via wireless connections, the communications network comprising:

a number of independent nodes, each node including at least one transceiver for communicating with a wireless communications device;

a server for controlling the operation of the network nodes; and,

a communications link for coupling the nodes to the server in series.

In accordance with a second aspect of the present invention, we provide a node for use in a communications network adapted to communicate with communications devices via wireless connections, the node including:

at least one transceiver for communicating with a wireless communications device;

a first port for coupling the node to the server via a communications link; and,

a second port for coupling the network node to another independent node via the communications link.

In accordance with a third aspect of the present invention, we provide a server for use in a communications network, the communications network having a number of independent nodes adapted to communicate with communications devices via wireless connections, the server including:

a processor for controlling the operation of the nodes;

a port for coupling the server to the nodes via a communications link; and,

a power supply coupled to the port for supplying power to the nodes via the communication link.

Accordingly, the present invention provides a communications network formed from a number of nodes each of which includes a transceiver for providing wireless connectivity. Each node is capable of transmitting or receiving data independently of the other nodes. The nodes are connected to a controlling server in series. This advantageously allows a number of nodes to be spread through a building whilst only requiring the presence of a single wiring link to interconnect all the nodes to the server. Accordingly, this allows centralized processing to be achieved whilst allowing the distributed nodes to provide wireless connectivity to other devices over a wide footprint area without the requirement for complicated wiring, such as in a network with a star topology.

Each node usually includes a first portion of a processing stack coupled to the transceiver, with the server including a second portion of the processing stack. In this case, the first and second portions of the processing stack are adapted to communicate with each other via the communications link. Accordingly, the system advantageously distributes processing between the node and the server allowing the server to maintain control of each node whilst allowing the nodes to communicate with communications devices independently. However, this could also be achieved by having all the processing located in the server with the nodes simply being provided in the form of remote transceivers.

When the processing stack is split between the nodes and the server, the first and second portions of the processing stack are typically coupled to the communications link via respective first and second TCP/IP stacks. Accordingly, in this case the communications link typically operates in accordance with a TCP/IP communications protocol. This is particularly advantageous as it allows for the efficient transfer of data between the nodes and the server using an extremely robust communications protocol. This is important to ensure that there are no errors in commands transferred between the first and second portions of the processing stack.

The second TCP/IP stack is typically adapted to provide a virtual connection to each first TCP/IP stack via the communications link. This ensures that each of the nodes can be controlled independently via a single serial connection between the server and the nodes. However, other forms of connection may also be suitable.

Typically the communications link comprises an Ethernet connection. This is particularly advantageous as many buildings already incorporate Ethernet connections, for example in local area networks (LANs) which can be reused to implement the present invention. Accordingly, currently existing LANs can be removed and the wiring used to implement a network according to the present invention.

The server usually includes a power supply which is coupled to the nodes via the communications link. This allows power to be transferred from the power supply to the nodes via the series communications link. Thus, this allows the communications link to be used not only for the transfer of data but also to ensure that each of the nodes is powered. This overcomes the need to have each node powered separately which can cause further restrictions on the positioning of nodes within a building.

The network is usually adapted to communicate with a communications device via a Bluetooth connection. In this case, the first and second portions of the processing step comprise first and second portions of a Bluetooth stack. The use of Bluetooth technology is particularly advantageous for this form of invention.

When the processing stack is a Bluetooth stack which is split into first and second portions between the nodes and the server, the Bluetooth stack is typically split at the HCI layer such that control commands can be transferred via the communications link in the HCI format. This is preferable as this reduces to a minimum the amount of information that is transferred via the communications link. In any event, Bluetooth stacks normally require an RS232 connection over which HCI format commands are transferred and the present invention advantageously uses this division which is already present in the Bluetooth stack As set out above, the nodes usually have a first port for coupling the node server and a second port for coupling the node to another node. In this case, the node may be connected to the server via an intermediate node such that the first port of the node is coupled to the second port of the intermediate node, with the first port of the intermediate node being coupled to the server.

It will be realized from the above that the network according to the first aspect of the present invention may be formed from nodes according to the second aspect of the present invention, when coupled to a server according to the third aspect of the present invention.

### BRIEF DESCRIPTION OF THE DRAWINGS

Examples of the present invention will now be described with reference to the accompanying drawings, in which:

FIG. 1 is a schematic diagram of a network utilizing distributed processing according to the present invention;

FIG. 2 is a schematic diagram of the Access Server of FIG. 1;

FIG. 3 is a schematic diagram of the Access Point of FIG. 1; and,

FIG. 4 is an example of the functionality of the network shown in FIG. 1.

### DETAILED DESCRIPTION

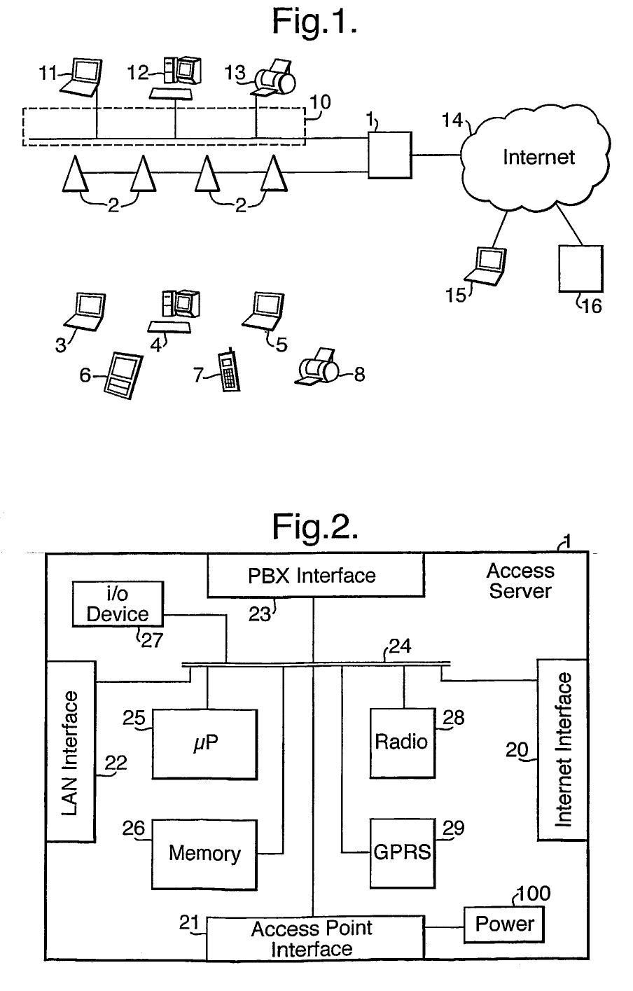

FIG. 1 shows a basic network arrangement which includes a wireless Internet Access Server 1 which is coupled to a number of local area network Access Points 2. The Access Points 2 are designed to communicate with a number of wireless communications devices 3,4,5,6,7,8 using a wireless communications protocol, which in this example is the Bluetooth protocol.

The wireless communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled printer, a Bluetooth enabled personal data assistant (PDA) or a Bluetooth headset. In this example, each of these devices will be able to communicate with the Access Points thereby allowing the devices to obtain data from, or send data to the Access Server.

In fact, the Access Server and Access Points can communicate with any Bluetooth enabled device. These include not only PCs, PDAs, and laptops but any of the following that have a Bluetooth port; a truck, a refrigerator, a baggage trolley, a keyboard etc.

The Access Server 1 is also optionally connected to a local area network 10 having a number of end stations 11,12,13. In this example, this allows the Access Server to be integrated with currently existing local area networks within a building.

The Access Server 1 can also be connected to a remote communications network 14, which in this example is the Internet. This allows the communications devices coupled to the Access Server to communicate with remote users 15 or Access Servers of other remote sites 16.

Accordingly, the Access Points 2 allow the wireless communications devices 3,4,5,6,7,8 to independently communicate with the LAN 10 and the Internet 14 via the Access Server 1. The Access Server will typically operate as a network server and can therefore typically store information to be retrieved by the communications devices, including information downloaded from the Internet.

The Access Server is shown in more detail in FIG. 2.

The Access Server includes an Internet interface 20, an Access Point interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

A power supply 100 is connected to the Access Point interface 21 to supply power to the Access Points, as will be explained in more detail below.

The processor 25 is typically an x86 type processor operating a Linux type operating system such as Red Hat Linux. This is particularly advantageous as the Linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the Access Server and the Access Point offers capabilities beyond the basic Bluetooth specification. These include advanced control of Bluetooth device state to improve throughput, and control of broadcast and multicast traffic streams to/from Bluetooth devices.

In this example, four different interfaces 20,21,22,23 are shown. However, it is not essential for the Access Server 1 to include all of these interfaces, depending on the particular configuration which is to be used, as will be explained in more detail below.

Thus, in order to enable Bluetooth communication between the wireless communication devices and the Access Server, only the Access Point interface 21, with appropriately connected Access Points 2, is required. In this case the Internet interface 20, the LAN interface 22 and the PBX interface 23 are not necessarily required. Alternatively, the Access Point interface need not be used if the Bluetooth radios are used instead. However, this will become clearer when various network configurations used by the Access Server are described in more detail below.

The Internet interface 20 is used primarily for providing an ISDN connection to an Internet service provider. However, the system can be reconfigured to use Ethernet, DSL or a POTS modem for Internet connectivity.

The Access Point interface 21 is effectively an Ethernet interface which is adapted to operate with the Access Points, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet. However, if alternative protocols such as Token Ring or ATM are used, then the software is adapted to translate the format of the data as it is transferred through the respective interface.

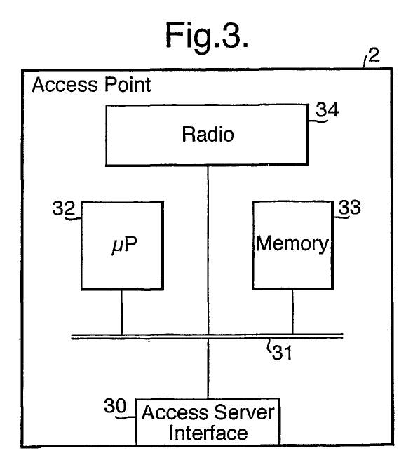

An Access Point according to the present invention is shown in FIG. 3. The Access Point includes an Access Server interface 30, for connecting the Access Point to the Access Server. The Access Server interface 30 is connected via a BUS 31 to a processor 32 and a memory 33. The BUS is also coupled to a number of Bluetooth radios 34(only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the Access Points are connected to the Access Point interface 21 using a daisy chain Ethernet connection. This allows a large number of Access Points 2 to be connected in series via a connection to the Access Point interface 21. Furthermore, in this case, power is supplied to the Access Points 2 by the power supply 100, via the connection from the Access Server 1. This is achieved by using a powered Ethernet connection, as will be appreciated by a person skilled in the art.

In use, each Access Point 2 is able to independently communicate with a number of communications devices 3,4,5,6,7,8 which are in range of the respective radio 34. Any data received at the radio is transferred to the memory 33 for temporary storage. The processor 32 will determine from the data the intended destination. If this is another Bluetooth device within range of the Access Point, the data will be transferred via the radio 34 to the appropriate communications device 3,4,5,6,7,8. Otherwise the data will be transferred via the BUS 31 to the Access Server interface 30 and on to the Access Server 1.

Upon receipt of the data by the Access Server 1, the Access Point interface 21 will temporarily store the data in the memory whilst the processor determines the intended destination of the data. The processor may also operate to translate the format of the data, if this is necessary. The data is then routed by the Access Server to the intended destination on either the LAN 2, the Internet 14 or alternatively, to a PBX network, as will be described in more detail below.

The traffic from Bluetooth devices (arriving through an Access Point or the Access Server) can be sent to the LAN through a number of different mechanisms; one is routing, another uses a technique called Proxy ARP to reduce the configuration needed. These mechanisms are bi-directional and also connect traffic from the LAN to Bluetooth devices.

Similarly, data can be transferred from the Access Server, via the Access Point interface 21 to an Access Point 2. In this case, the Access Point 2 receives the data and transfers it into the memory 33. The processor 32 then uses the data to determine the intended destination communication device before routing the data appropriately.

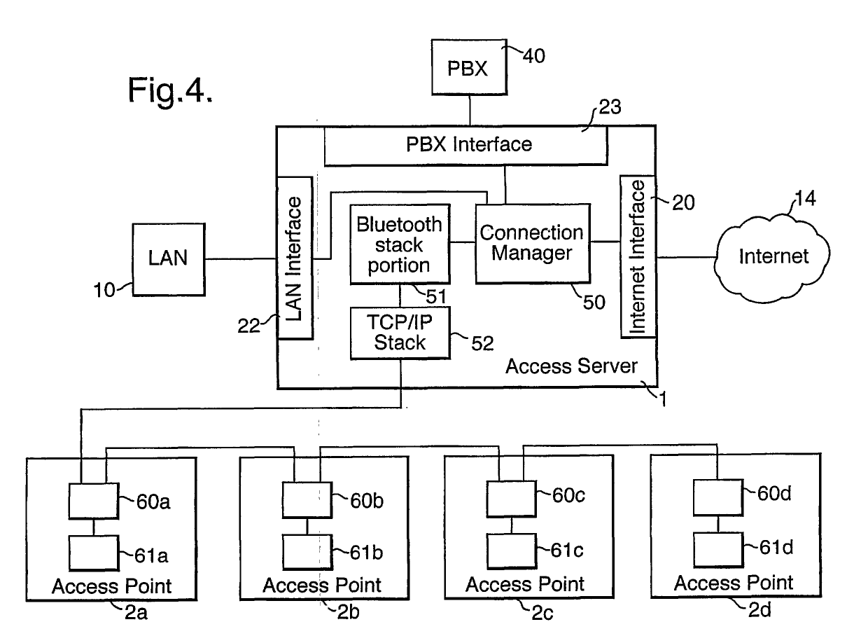

The functionality of the operation of the Access Server 1 and the Access Point 2, in accordance with the present invention will now be described with reference to FIG. 4.

In this example, in order to allow the system to function correctly the operation of the Bluetooth connections via the Access Points 2a,2b,2c,2d are controlled by the Access Server 1.

Under normal circumstances, a Bluetooth connection is controlled using a Bluetooth stack which operates to generate commands for controlling the operation of the Bluetooth radios, as well as to translate data into a format suitable for transfer via a Bluetooth connection. Thus, in order to achieve the connectivity of the present invention, each Access Point 2a,2b,2c,2d includes a respective first Bluetooth stack portion 61a,61b,61c,61d. Similarly, the Access Server includes a respective second Bluetooth stack portion 51. Thus, in this situation, the Bluetooth stack is effectively split between the Access Points 2a,2b,2c,2d and the Access Server 1, as will be described in more detail below.

Thus, as shown in this example, the Access Server 1 includes a connection manager 50 which is coupled to the Internet interface 20, the LAN Interface 22 and the PBX Interface 23, as well as being coupled to the second Bluetooth stack portion 51 and a TCP/IP stack 52, as shown. The connection manager is a software implemented device which is typically implemented using the processor 25.

The second Bluetooth stack portion 51 and TCP/IP stack 52 are also software implemented and again this may be achieved by the processor 25. More typically however, the second Bluetooth stack portion and the TCP/IP stack are implemented by the processor in the Access Point interface 21. However, this is not important for the operation of the present invention.

In use, the connection manager 50 operates to provide control signals for controlling the operation of the Internet interface 20, the Access Point interface 21, the LAN interface 22 and the PBX interface 23. Similarly, the connection manager 50 controls the transfer of data through the Access Server 1.

As also shown in FIG. 4, the Access Points 2a,2b,2c,2d include respective TCP/IP stacks 60a,60b,60c,60d and respective first Bluetooth stack portions 61a,61b,61c,61d. Again, the TCP/IP stacks 60a,60b,60c,60d and the first Bluetooth stack portions may be implemented within the Access Server interface 30, or within the processor 32 of the respective Access Point 2a,2b,2c,2d.

The operation of one of the Access Points 2 and the Access Server 1 will now be described. Data received at the Access Point 2, via the Bluetooth radio 34, is typically temporarily stored in the memory 33 before being transferred to the processor 32. At this stage, the second Bluetooth stack portion 61 is used to place the data into the Bluetooth HCI (Host Controller Interface) format suitable for transmission over a connection; such as an RS232 connection, in accordance with the Bluetooth specification.

In the present example, the data is transferred to the respective TCP/IP stack 60 which converts the data into a format suitable for transmission over the Ethernet connection to the Access Server 1. The data is then transferred in accordance with normal Ethernet procedures.

Upon receipt of the data at the Access Server 1 the data is transferred to the TCP/IP stack 52 which converts the data back into the Bluetooth HCI format for transfer over an RS232 connection to the second Bluetooth stack portion 51. The second Bluetooth stack portion 51 operates to translate the data from HCI format into the basic payload data which can then be transferred onto one of the Internet interface 20, the LAN interface 22 or the PBX interface 23.

Transfer of data from the Access Server 1 to one of the Access Points 2 occurs in a similar manner with each Access point capable of receiving data independently and will therefore not be described in detail.

In addition to the features described above, if the Access Server 1 is coupled to a number of Access Points 2a,2b,2c,2d then it is typical for the TCP/IP stack 52 to provide virtual connections to each of the TCP/IP stacks 60a,60b,60c,60d. In this manner, data received at the TCP/IP stack 52 can be transferred directly to the respective destination TCP/IP stack 60A,60b,60c,60d via the virtual connection. This virtual connection helps ensure that the data is transferred quickly and without errors thereby helping maintain the operation of the distributed Bluetooth processing.

The Access Points 2a,2b,2c,2d are connected in series via the TCP/IP stacks 60a,60b,60c,60d, as shown. Accordingly, any data received by the TCP/IP stack 60a which is destined for the TCP/IP stack 60b will simply be transferred directly through the TCP/IP stack 60a via the virtual connection. The advantage of connecting the Access Points in series is that power can be supplied to the Access Points via the Ethernet communications link. Accordingly, the power supply 100 can be used to power each of the Access Points 2a,2b,2c,2d respectively.

The routing of the data is achieved in accordance with routing information which is interpreted by the connection manager 50. The connection manager 50 also determines various information about the Bluetooth connection from the second Bluetooth stack portion 51. This typically includes information concerning the signal strength between the Access Points 2 and the communications device 3,4,5,6,7,8 currently connected to the Access Point. The determination of the signal strength can be either a direct determination of the strength of signal that is required to communicate with the communications device, or alternatively or additionally, this may be an indication of the number of errors received per unit time.

Accordingly, as will be appreciated from the above, the Access Server 1 and one of the Access Points 2 will therefore act to provide a Bluetooth connection to the communications device which is controlled by the Access Server 1. Accordingly, in this example, the Access Points 2 function as network nodes, with the Access Server 1 forming the network server to control the operation of the network.

As will be appreciated by a person skilled in the art, this allows a number of different network configurations to be implemented, as are described in more detail in the copending British patent application GB0014431.1 filed on Jun. 13, 2000.

1. A communications network adapted to communicate with communications devices via wireless connections, the communications network comprising:
a number of independent nodes, each node including at least one transceiver for communicating with a wireless communications device;
a server for controlling the operation of the network nodes; and,
a communications link for coupling the nodes to the server in series.

2. A communication network according to claim 1, each node including a first portion of a processing stack coupled to the transceiver, and the server including a second portion of the processing stack, the first and second portions of the processing stack being adapted to communicate with each other via the communication link.

3. A communications network according to claim 2, wherein the first and second portions of the processing stack are coupled to the communications link via respective first and second TCP/IP stacks, the communications link operating in accordance with a TCP/IP communications protocol.

4. A communications network according to claim 3, wherein the second TCP/IP stack being adapted to provide a virtual connection to each first TCP/IP stack via the communications link.

5. A communications network according to any of the preceding claims, wherein the communications link comprises an Ethernet connection.

6. A communications network according to any of the preceding claims wherein the server includes a power supply, and wherein power is coupled to the nodes via the communications link.

7. A communications network according to any of the preceding claims, wherein the network is adapted to communicate with the communications devices via a Bluetooth connection, the first and second portions of the processing stack comprising first and second portions of a Bluetooth stack.

8. A node for use in a communications network adapted to communicate with communications devices via wireless connections, the node including:
at least one transceiver for communicating with a wireless communications device;
a first port for coupling the node to the server via a communications link; and,
a second port for coupling the network node to another independent node via the communications link.

9. A node according to claim 8, wherein the node is coupled to the server via at least one intermediate node, the first port of the node being coupled to the second port of the intermediate node.

10. A node according to claim 8 or claim 9, wherein the node further comprises a first portion of a processing stack, the first portion being coupled to the transceiver and to the first and second ports, and being adapted to communicate with a second portion of the processing stack located in the server.

11. A node according to any of claims 8 to 10, the node being adapted to communicate with the communications devices via a Bluetooth connection.

12. A node according to claim 11, when dependent on claim 10, wherein the processing stack is a Bluetooth stack.

13. A server for use in a communications network, the communications network having a number of independent nodes adapted to communicate with communications devices via wireless connections, the server including:
a processor for controlling the operation of the nodes;
a port for coupling the server to the nodes via a communications link; and,
a power supply coupled to the port for supplying power to the nodes via the communication link.

14. A server according to claim 13, wherein the processor forms a second portion of a processing stack, the second portion being adapted to communicate with first portions of the processing stack located in the nodes.

15. A server according to claim 13 or claim 14, wherein the nodes are adapted to communicate with the communications devices via a Bluetooth connection, and wherein the processing stack is a Bluetooth stack.

16. A communications network according to any of claims 1 to 7, the network comprising a number of nodes according to any of claims 8 to 12 coupled to a server according to any of claims 13 to 15 via a communications link.
